(19) United States
(12) Patent Application Publication
(10) Pub. No.: US 2006/0091654 A1
(43) Pub. Date: May 4, 2006

(54) Sensor system with radar sensor and vision sensor

(75) Inventors: Bernard Guy De Mersseman, Royal Oak, MI (US); Stephen Wayne Decker, Clarkston, MI (US)

Correspondence Address: AUTOLIV ASP, 3350 AIRORT ROAD, OGDEN, UT, 84405, US

(73) Assignee: Autoliv ASP, Inc.

(21) Appl. No.: 10/981,348

(22) Filed: Nov. 4, 2004

(51) Int. Cl. B60R 21/32

(52) U.S. Cl. 280/735; 342/72

(57) ABSTRACT

A motor vehicle crash sensor system for activating an external safety system such as an airbag in response to the detection of an impending collision target. The system includes a radar sensor carried by the vehicle providing a radar output related to the range and relative velocity of the target. A vision sensor is carried by the vehicle which provides a vision output related to the bearing and bearing rate of the target. An electronic control module receives the radar output and the vision output for producing a deployment signal for the safety system.

### FIELD OF THE INVENTION

This invention relates to a sensor system for a motor vehicle impact protection system.

### BACKGROUND AND SUMMARY OF THE INVENTION

Enhancements in automotive safety systems over the past several decades have provided dramatic improvements in vehicle occupant protection. Presently available motor vehicles include an array of such systems, including inflatable restraint systems for protection of occupants from frontal impacts, side impacts, and roll-over conditions. Advancements in restraint belts and vehicle interior energy absorbing systems have also contributed to enhancements in safety. Many of these systems must be deployed or actuated in a non-reversible manner upon the detection of a vehicle impact to provide their beneficial effect. Many designs for such sensors are presently used to detect the presence of an impact or roll-over condition as it occurs.

Attention has been directed recently to providing deployable systems external to the vehicle. For example, when an impact with a pedestrian or bicyclist is imminent, external airbags can be deployed to reduce the severity of impact between the vehicle and pedestrian. Collisions with bicyclists and pedestrians account for a significant number of motor vehicle fatalities annually. Another function of an external airbag may be to provide greater compatibility between two vehicles when an impact occurs. While an effort has been made to match bumper heights for passenger cars, there remains a disparity between bumper heights, especially between classes of passenger vehicles, and especially involving collisions with heavy trucks. Through deployment of an external airbag system prior to impact, the bag can provide enhancements in the mechanical interaction between the vehicles in a manner which provides greater energy absorption, thereby reducing the severity of injuries to vehicle occupants.

For any external airbag system to operate properly, a robust sensing system is necessary. Unlike crash sensors which trigger deployment while the vehicle is crushing and decelerating, the sensing system for an external airbag must anticipate an impact before it has occurred. This critical “Time Before Collision” is related to the time to deploy the actuator (e.g. 30-200 ms) and the clearance distance in front of the vehicle (e.g. 100-800 mm). Inadvertent deployment is not only costly but may temporarily disable the vehicle. Moreover, since the deployment of an airbag is achieved through a release of energy, deployment at an inappropriate time may result in undesirable effects. This invention is related to a sensing system for an external airbag safety system which addresses these design concerns.

Radar detection systems have been studied and employed for motor vehicles for many years. Radar systems for motor vehicles operate much like their aviation counterparts in that a radio frequency signal, typically in the microwave region, is emitted from an antenna on the vehicle and the reflected-back signal is analyzed to reveal information about the reflecting target. Such systems have been considered for use in active braking systems for motor vehicles, as well as obstacle detection systems for vehicle drivers. Radar sensing systems also have applicability in deploying external airbags. Radar sensors provide a number of valuable inputs, including the ability to detect the range to the closest object with a high degree of accuracy (e.g. 5 cm). They can also provide an output enabling measurement of closing velocity to a target with high accuracy. The radar cross section of the target and the characteristics of the return signal may also be used as a means of characterizing the target.

Although information obtained from radar systems yield valuable data, exclusive reliance upon a radar sensor signal for deploying an external airbag has certain negative consequences. As mentioned previously, deployment of the external airbag is a significant event and should only occur when needed in an impending impact situation. Radar sensor systems are, however, prone to “false-positive” indications. These are typically due to phenomena such as a ground reflection, projection of small objects, and software misinterpretation, which faults are referred to as “fooling” and “ghosting”. For example, a small metal object with a reflector type geometry can return as much energy as a small car and as such can generate a collision signal in the radar even when the object is too small to damage the vehicle in a substantial way. Also, there may be “near miss” situations where a target is traveling fast enough to avoid collision, yet the radar sensor system would provide a triggering signal for the external airbag.

In accordance with this invention, data received from a radar sensor is processed along with vision data obtained from a vision sensor. The vision sensor may be a stereo or a three-dimensional vision system that is mounted to the vehicle. The vision sensor can be a pair of 2 dimensional cameras that are designed to work as a stereo pair. By designing a stereo pair, the set of cameras can generate a 3 dimensional image of the scene. The vision subsystem can be designed with a single camera used in conjunction with modulated light to generate a 3 dimensional image of the scene. This 3 dimensional image is designed to overlap the radar beams so that objects will be sensed within the same area. Both the radar and 3 dimensional vision sensors measure a range to the sensed object as one of their sensed features. Since this is the common feature, it is used to correlate information from each sensor. This information correlation is important for correct fusion of the independently sensed information especially in a multiple target environment. The fusion of radar and vision sensing systems data provide a highly reliable non-contact sensing of an impending collision. The fusion mechanism is the overlap of radar range and vision depth information. The invention functions to provide a signal that an impact is imminent. This signal of an impending crash is generated from an object approaching the vehicle from any direction in which the sensor system is installed. In addition to an indication of impending crash, the sensor system will also indicate the potential intensity of the crash. The exact time of impact, and the direction of the impact is also indicated by this fused sensor system. The intensity of the crash is determined by the relative size of the striking object, and the speed with which the object is approaching the host vehicle. The time, and direction of the impact is determined by repeated measurements of the object's position. This sequence of position data points can be used to compute an objects trajectory, and by comparing this trajectory with that of the host vehicle, a point of impact can be determined. The closing velocity can also be determined by using the position data and trajectory calculations. The advantage of this invention is the high reliability the sensor fusion combination provides.

Additional benefits and advantages of the present invention will become apparent to those skilled in the art to which the present invention relates from the subsequent description of the preferred embodiment and the appended claims, taken in conjunction with the accompanying drawings. These benefits include being able to begin deploying the airbags sooner so their deployment speed can be reduced. With more time to inflate, the airbag size can be increased. With advanced notice of an impending crash, the seatbelts can be tightened by triggering an electric pre-pretensioner. Tightening the seatbelts increases their effectiveness. The seating position and headrest position can be modified, based on advanced crash information to increase their effectiveness in a variety of crash scenarios. Additional time to deploy enables safety devices that are slower in comparison to today's airbags. Electric knee bolster extenders can be enabled to help hold the occupant in position during a crash. Advance warning also enables the windows and sunroof to close to further increase crash safety. External structures can be modified with advance notice of an impending crash. Structures such as extendable bumpers and external airbags can be deployed to further reduce the crash forces transmitted to the vehicle's occupants.

### BRIEF DESCRIPTION OF THE DRAWINGS

FIG. 1 is an overhead view of a representative motor vehicle incorporating the crash sensor system in accordance with this invention showing the sensors in diagrammatic form;

FIG. 2 is a signal and decision flow chart regarding the radar sensor of the sensor system of this invention;

FIG. 3 is a signal and decision flow chart regarding the vision systems of the sensor system of this invention;

FIG. 4 is a flow chart showing decision level fusion logic where decisions made by independent sensors with overlapping fields of view are combined to make a more reliable decision level fusion decision; and

FIG. 5 is a flow chart showing feature level fusion logic where similar features from each sensor are combined to make a decision based on the combined multi-sensor fused features.

### DETAILED DESCRIPTION OF THE INVENTION

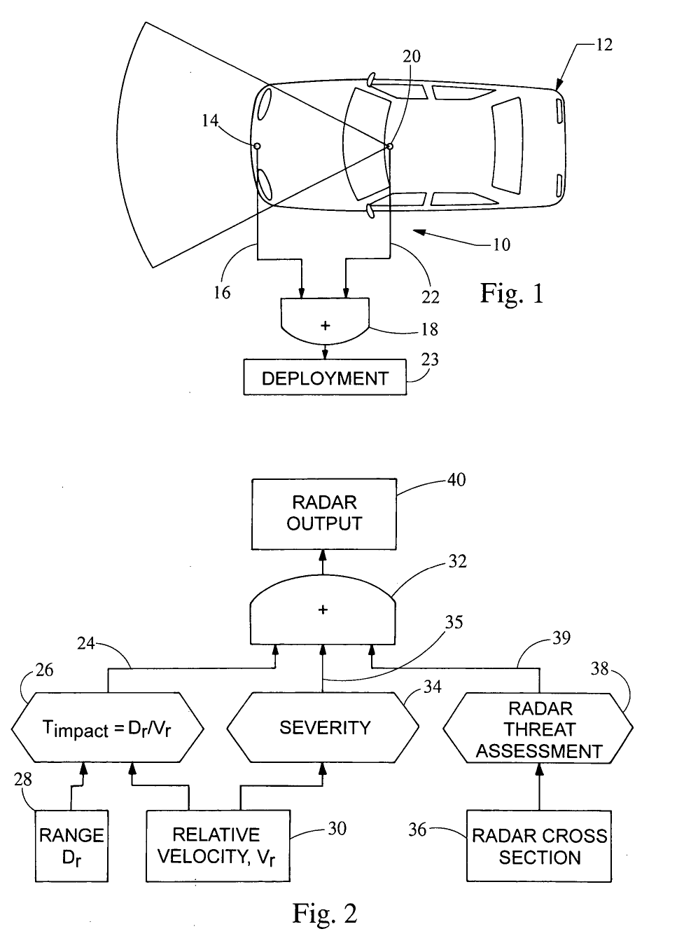

Now referring to FIG. 1, a sensor system 10 is shown with an associated vehicle 12. The sensor system 10 is configured for a forward looking application. However, the sensor system 10 can be configured to look rearward or sideways with the same ability to sense an approaching object and prepare the vehicle 12 for the crash. In a side-looking, or rearward looking application, the sensors would have overlapping fields of view, as shown in the forward looking application in FIG. 1.

The sensor system 10 includes a radar sensor 14 which receives a radio frequency signal, preferably in the microwave region emanating from an antenna (not shown). Radar sensor 14 provides radar output 16 to an electronic control module (ECM) 18. A vision sensor 20 is preferably mounted to an upper portion of the vehicle 12, such as, along the windshield header aimed forward to provide vision information. Vision sensor 20 provides vision output 22 to an ECM 18. The ECM 18 combines radar output 16 and the vision output 22 to generate a deployment decision 23.

Now with reference to FIG. 2, a diagram of the signal and decision flow related to radar sensor 14 is provided. The radar sensor 14 analyzes a radio frequency signal reflected off an object to obtain a range measurement 28, a closing velocity 30, and a radar cross section 36.

A time of impact estimate 26 is calculated based on range measurement 28 and the closing velocity 30. The range measurement 28 is the distance between the object and vehicle 12. Radar sensor 14 provides distance information with high accuracy, typically within 5 cm. The closing velocity 30 is a measure of the relative speed between the object and the vehicle 12. The time of impact estimate 26 is provided to block 32 along input 24. The time of impact estimate 26 is compared with the necessary time to deploy the safety device, such as an external air bag. Typically deployment time of an external airbag is between 200 ms and 300 ms. In addition, the range measurement 28 is compared with the necessary clearance distance from the vehicle 12 to deploy the safety device. Typically clearance distance for an external air bag is between 100 mm to 800 mm.

The closing velocity 30 is also used to determine the severity of impact as denoted by block 34. High closing velocities are associated with a more severe impact, while lower closing velocities are associated with a less severe impact. The severity of impact calculation is provided to block 32 as input 35.

The radar cross section 36 is a measure of the strength of the reflected radio frequency signal. The strength of the reflected signal is generally related to the size and shape of the object. The size and shape is used to access the threat of the object, as denoted by block 38. The threat assessment from block 38 is provided to block 32 as input 39. Block 32 of the ECM 18 processes the time of impact, severity of impact, and threat assessment to provide a radar output 40. In this embodiment, the radar output 40 is indicative of a deployment decision.

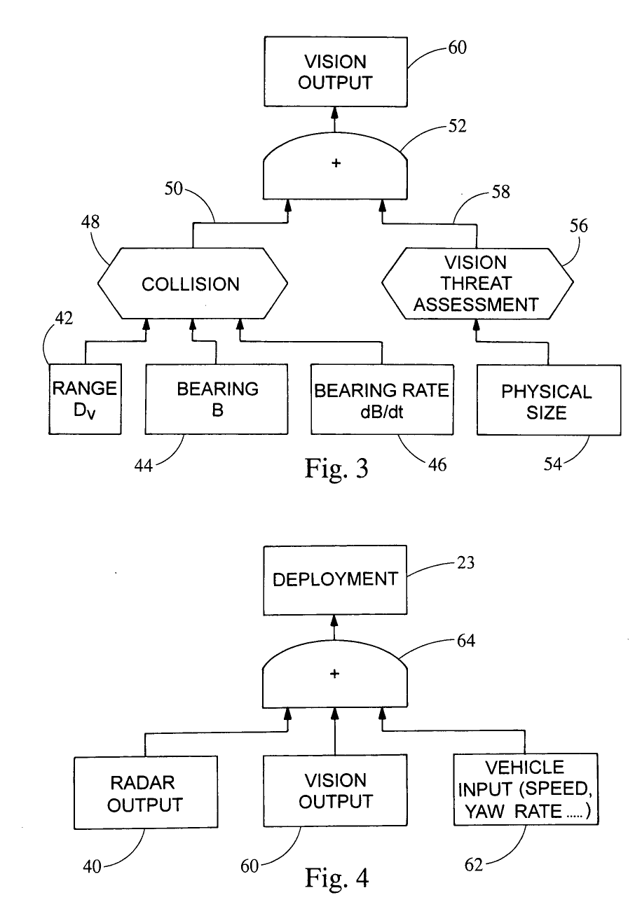

FIG. 3 provides a signal and decision flow chart related to the processing of information from vision sensor 20. The vision sensor 20 provides a vision range measurement 42, a bearing valve 44, a bearing rate 46, and a physical size 54 of the object.

By using a stereo pair of cameras or a light modulating 3 dimensional imaging sensor, the vision sensor 20 can determine the vision range measurement 42 to indicate the distance from the vehicle 12 to the object. The bearing valve 44 is related to an angular measure of object with respect to a datum of vehicle 12 (e.g. an angular deviation from a longitudinal axis through the center of the vehicle 12). The rate of change of the bearing valve 44, with respect to time, is the bearing rate 46. The vision range measurement 42, bearing valve 44, and the bearing rate 46 are used to generate a collision determination as denoted by 48. The collision determination from block 48 is provided as input 50 to block 52.

The vision sensor 20 also measures the physical size 54 of the object. The physical size 54 is used to assess the threat of the object, as denoted by block 56. The threat assessment is provided to block 52 as input 58. The collision determination from block 48 and the threat assessment from block 56 are used in block 52 to determine a vision output 60. In this embodiment, the vision output 60 is indicative of a deployment decision.

FIG. 4 illustrates the integration or fusion of the radar output 40 and vision output 60 to provide deployment signal 23. The combining of decisions, such as, vision deployment and radar deployment is referred to as decision fusion. Both the radar sensor 14 and vision sensor 20 independently provide a determination whether to deploy the safety device. However, ECM 18 considers decision outputs from both sensors 14, 20 in block 64 and applies a basic function to arrive at a fused decision, specifically, the deployment decision signal 23. For example, ECM 18 may be programmed to generate deployment signal 23 only when radar output 40 indicates an impending collision and vision output 60 confirms the impending collision.

The radar output 40 and the vision output 60 may be considered along with vehicle parameters 62, such as vehicle speed, yaw rate, steering angle, and steering rate. The vehicle parameters 62 are evaluated in conjunction with the radar output 40 and the vision output 60 to enhance the reliability of the deployment decision signal 23.

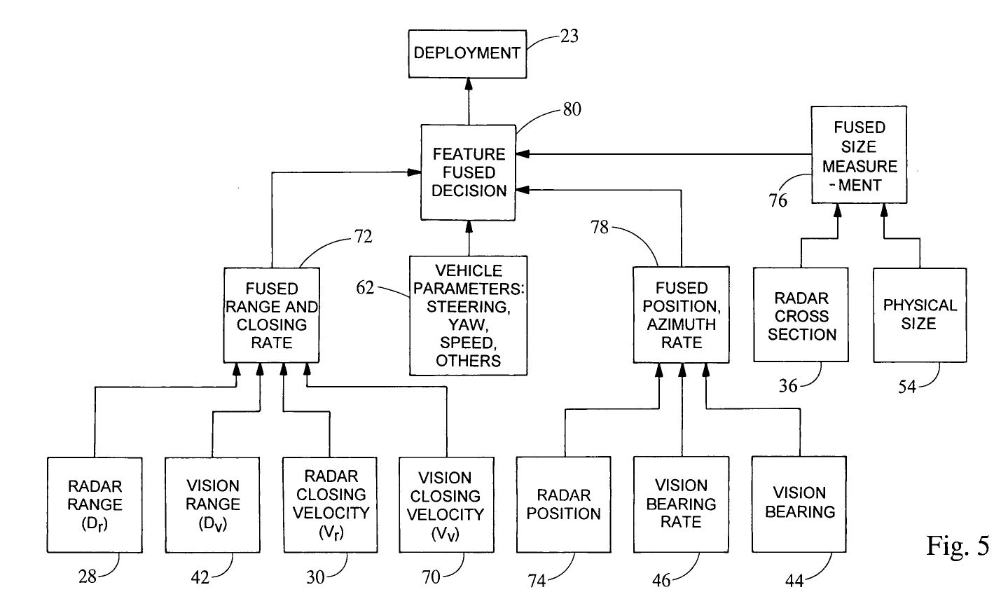

Referring now to FIG. 5, since each sensor has some very accurate features and some less accurate features, sensor system 10 may also be configured to combine the attributes of both radar sensor 14 and vision sensor 20 to provide a deployment signal 23. In this embodiment, the radar output is comprised of a plurality of radar measurements including the range measurement 28, the radar closing velocity 30, and the radar position 74, while the vision output is comprised of a plurality of vision measurements including the vision range measurement 42, vision closing velocity 70, vision bearing rate 46, and vision bearing valve 44. The deployment signal 23 is based on a combination of radar and vision measurements from each sensor. The combining of discrete measurements from separate sensors to improve reliability of a measurement is referred to as feature fusion.

For example, the closing velocity 30 as measured by radar sensor 14 is combined with closing velocity 70 as measured by vision sensor 20 to determine a fused closing velocity as denoted by block 72. Similarly, the range measurement 28 from radar sensor 14 is fused or combined with the vision range measurement 42 as measured by vision sensor 20 to determine a fused range measurement, also denoted by block 72. The precision of the fused range measurement is achieved primarily through radar sensor 14. Although the vision range measurement 42 is not as accurate as the radar range measurement 28, comparison between the radar range measurement 28 and the vision range measurement 42 provides improved reliability. In addition, the vision range measurement 42 is accurate enough to enable correlation of features and fusion with the radar sensor 14.

In order to correlate features from different sensors a reference must be used to associate each similar measurement as sensed by each independent sensor. Use of a reference is increasingly important in a multiple target scenario to decrease the likelihood of attributing a measurement to the wrong target. Since both sensors determine range, it is the reference used to as a basis to combine all features in the feature fusion process.

The radar position 74, vision bearing 44, and vision bearing rate 46 are combined to determine a fused position and azmuth rate as denoted by block 78. Similarly, the radar cross section 36 and the physical size measurement 54 from the vision sensor 20, may be combined into a fused size measurement as denoted by block 76. The fused range and closing range in block 72, the fused position and azmuth rate in block 78, and the fused size measurement in block 76 are combined with other vehicle parameters 62 to generate a fused feature decision in block 80. Thus, the analysis, in block 80, of attributes from both the radar sensor 14 and the vision sensor 20, in the form of the fused feature measurements, provides a deployment signal 23 with high reliability. While the above description constitutes the preferred embodiment of the present invention, it will be appreciated that the invention is susceptible to modification and change without departing from the proper scope and fair meaning of the accompanying claims.

1. A sensor system for detecting an impending collision of a vehicle, the sensor system comprising:
a radar sensor carried by the vehicle providing a radar output based on a plurality of radar measurements including a radar range measurement and a radar closing velocity of an object with respect to the vehicle;
a vision sensor carried by the vehicle for providing a vision output based on a plurality of vision measurements including a vision range measurement and bearing value of the object with respect to the vehicle; and
an electronic control module configured to receive the radar output and the vision output and produce a deployment signal for a safety device which is dependent upon evaluation of both the radar output and the vision output.

2. The sensor system according to claim 1, wherein the electronic control module is configured to use decision fusion processing to increase the reliability of determining an impending crash.

3. The sensor system according to claim 2, wherein vision output and the radar output correspond to a deployment decision.

4. The sensor system according to claim 1, wherein the electronic control module is configured to use feature fusion processing to increase the reliability of determining the impending collision.

5. The sensor system according to claim 4, wherein the electronic control module is configured to calculate a fused range measurement based on the radar range measurement and the vision range measurement.

6. The sensor system according to claim 4, wherein the electronic control module is configured to calculate a fused closing velocity based on the radar closing velocity and a vision closing velocity.

7. The sensor system according to claim 4, wherein the electronic control module generates the deployment signal based on the radar range value, the vision range value, the radar closing velocity, the vision closing velocity, the bearing value, and the bearing rate.

8. The sensor system according to claim 4, wherein the electronic control module is configured to use a range value from the vision system as a reference to combine the vision output and the range output.

9. The sensor system according to claim 1, wherein the safety system is an external inflatable airbag.

10. The sensor system according to claim 1, wherein the radar output includes a radar cross section measure of the object.

11. The sensor system according to claim 1, wherein vision output includes a vision signal related to the physical size of the object.

12. The sensor system according to claim 1, wherein the electronic control module generates the deployment signal based on vehicle parameters including at least one of a vehicle speed and a yaw rate value.

13. The sensor system according to claim 1, wherein the radar sensor operates in a microwave region.

14. The sensor system according to claim 1, wherein the vision sensor is a stereo vision sensor.

15. A motor vehicle crash sensor according to claim 1, wherein the vision sensor is a light modulating 3 dimensional imaging sensor.

16. A sensor system for detecting an impending collision of a vehicle, the sensor system comprising:
a radar sensor carried by the vehicle providing a radar output based on a plurality of radar measurements including a radar cross section, a radar range measurement, and a radar closing velocity of an object;
a vision sensor carried by the vehicle for providing a vision output based on a plurality of vision measurements including a size measurement, a vision range measurement and bearing value of the object; and
an electronic control module configured to receive the radar output and the vision output and produce a deployment signal for a safety device which is dependent upon evaluation of both the radar output and the vision output.

17. The sensor system according to claim 16, wherein the electronic control module is configured to use decision fusion processing to increase the reliability of determining an impending crash.

18. The sensor system according to claim 17, wherein vision output and the radar output correspond to a deployment decision.

19. The sensor system according to claim 16, wherein the electronic control module is configured to use feature fusion processing to increase the reliability of determining the impending collision.

20. The sensor system according to claim 19, wherein the electronic control module is configured to calculate a fused range measurement based on the radar range measurement and the vision range measurement.

21. The sensor system according to claim 19, wherein the electronic control module is configured to calculate a fused closing velocity based on the radar closing velocity and a vision closing velocity.

22. The sensor system according to claim 19, wherein the electronic control module generates the deployment signal based on the radar range value, the vision range value, the radar closing velocity, the vision closing velocity, the bearing value, and the bearing rate.

23. The sensor system according to claim 19, wherein the electronic control module is configured to use a range value from the vision system as a reference to combine the vision output and the range output.

24. The sensor system according to claim 16, wherein the safety system is an external inflatable airbag.

25. The sensor system according to claim 16, wherein the electronic control module generates the deployment signal based on vehicle parameters including at least one of a vehicle speed and a yaw rate value.
